(19) United States
(12) Patent Application Publication
(10) Pub. No.: US 2020/0141427 A1
(43) Pub. Date: May 7, 2020

(54) A THROTTLING LOCKING VALVE

(71) Applicant: HEMA ENDUSTI ANONIM SIRKETI, TEKIRDAG (TR)

(72) Inventors: SAMET NAK, TEKIRDAG (TR); OLCAY TEZCAN, TEKIRDAG (TR); OZGUR SAVASCI, TEKIRDAG (TR)

(21) Appl. No.: 16/621,742

(22) PCT Filed: Mar. 26, 2018
(86) PCT No.: PCT/TR2018/050116

§ 371 Date: Dec. 13, 2019

(30) Foreign Application Priority Data
Jun. 15, 2017 (TR) 2017/08850

(51) Int. Cl. F15B 13/01; A01B 63/10

(52) U.S. Cl. CPC F15B 13/01; A01B 63/10

(57) ABSTRACT

The present invention relates to a throttling locking valve (10) for a control valve used in tractor hydraulic lifters and having a body (20) and a locking screw (30) provided inside the body (20). As an improvement, the subject matter throttling locking valve (10) comprises a center opening (21) wherein the locking screw (30) is placed inside the body (20), and a screw thread (23) provided at the wall of the center opening (21) and at least one threaded part (32) provided on the locking screw (30).

### TECHNICAL FIELD

The present invention relates to throttling locking valves used in control valves controlling lifting and lowering functions of hydraulic lifters provided in tractors.

### PRIOR ART

In tractors, there are hydraulic lifters generally at the rear part of the tractor. There are control valves in order to control the lifting and lowering functions of hydraulic lifters.

The beginning of the lifting and lowering movement and staying in the neutral position are very important during operation of the control valves. Particularly the lowering movement shall be realized in a controlled manner. If the lowering movement takes place in an uncontrolled and rapid manner, the carried materials may fall, and the movement may lead to safety problems.

In order to control the lowering movement, there are throttling locking valves provided inside the control valves. During lowering, the throttling locking valves control the amount of fluid flowing from the cylinder towards the lowering valve. In order to provide this, the throttling locking valve is provided in an adjustable manner and the throttling locking valve narrows and widens the flow cross section and changes the flow speed and thus changes the lowering speed. In throttling locking valves, there is a pin provided in a movable manner inside a body. In order to prevent removal of the pin from the body, spiral or grooved pins are used. However, forces exerted by the operator or the operational conditions may lead to breakages of the pins and occurrence of serious problems.

As a result, because of all of the abovementioned problems, an improvement is required in the related technical field.

### BRIEF DESCRIPTION OF THE INVENTION

The present invention relates to a throttling locking valve, for eliminating the above mentioned disadvantages and for bringing new advantages to the related technical field.

An object of the present invention is to provide a throttling locking valve with increased resistance.

In order to realize all of the abovementioned objects and the objects which are to be deducted from the detailed description below, the present invention is a throttling locking valve for a control valve used in tractor hydraulic lifters and having a body and a locking screw provided inside the body. Accordingly, the subject matter throttling locking valve comprises a center opening wherein the locking screw is placed inside the body, and a screw thread provided at the wall of the center opening and at least one threaded part provided on the locking screw. Thus, the locking screw is rotated and it can move in the direction of the center axis. Moreover, when the locking screw is rotated at a predetermined amount, the threaded part is stopped to the end of the screw thread and prevents further movement of the locking screw. Even if the user tries to rotate further, no movement occurs. On the other hand, since weak and brittle components are not used for delimiting movement, the resistance of the throttling locking valve is increased.

In a preferred embodiment of the invention, the locking screw comprises at least one handle part extending outwardly from one side of the body. Thus, the locking screw can be easily rotated from outside of the body.

In a preferred embodiment of the invention, at least one peripheral channel is provided at the outer wall on the side of the handle part of the locking screw and at least one sealing element is provided inside said peripheral channel. Thus, foreign substances like powder are prevented from entering into the body from the handle part side, in other words, from the outer side of the throttling locking valve.

In a preferred embodiment of the invention, the locking screw comprises at least one pin part extending outwardly from one side of the body.

In a preferred embodiment of the invention, at least one valve plug is provided on the pin part. Thus, throttling function can be realized in the control valve where it is used on the throttling locking valve.

In a preferred embodiment of the invention, the valve plug comprises at least one inner channel provided at a bore thereof wherein the pin part is placed and at least one first elastic element is provided inside said inner channel. Thus, fluid or dirt is prevented from entering into the body during the usage of the throttling locking valve.

In a preferred embodiment of the invention, at least one outer channel is provided on the outer wall of the valve plug and at least one second elastic element is provided inside said outer channel. Thus, fluid is prevented from entering into the body during the usage of the throttling locking valve.

In a preferred embodiment of the invention, a first part and a second part, which form the center opening, is provided.

In a preferred embodiment of the invention, at least one step is provided between the second part and the first part having a greater diameter than the second part.

### BRIEF DESCRIPTION OF THE FIGURES

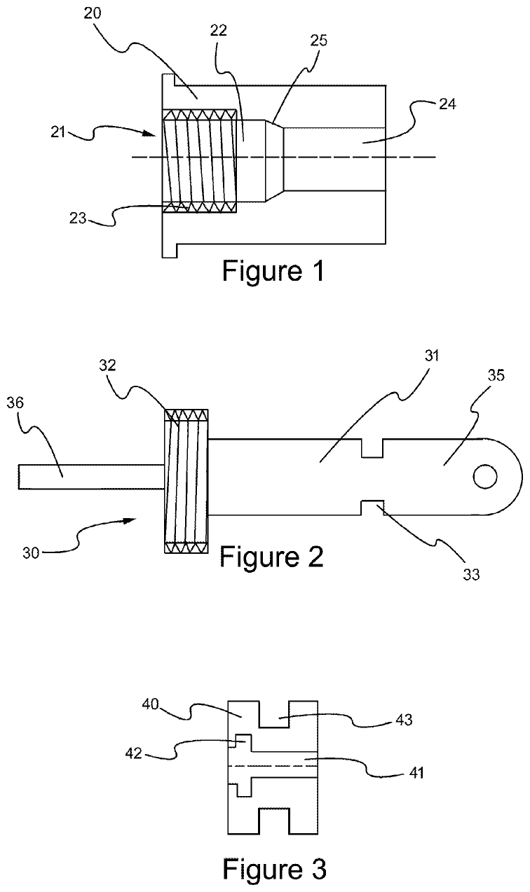

In FIG. 1, a representative cross sectional view of the body of the subject matter throttling locking valve is given.

In FIG. 2, a representative cross sectional view of the locking screw of the subject matter throttling locking valve is given.

In FIG. 3, a representative cross sectional view of the valve plug of the subject matter throttling locking valve is given.

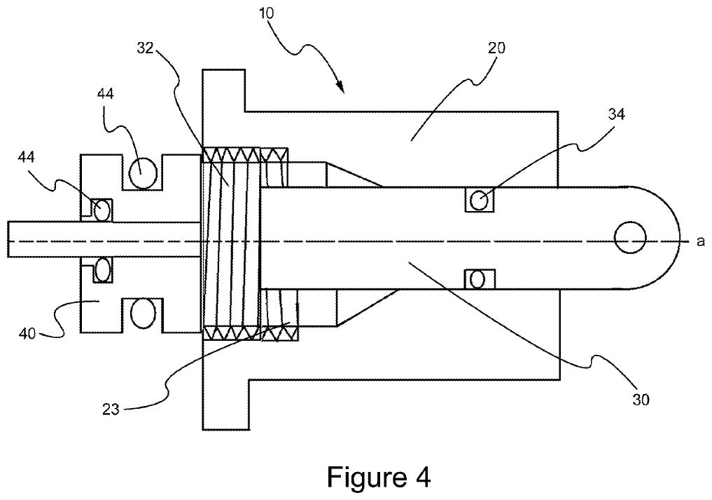

In FIG. 4, a representative cross sectional view of the subject matter throttling locking valve is given.

### DETAILED DESCRIPTION OF THE INVENTION

In this detailed description, the subject matter throttling locking valve (10) is explained with references to examples without forming any restrictive effect only in order to make the subject more understandable.

The subject matter throttling locking valve (10) has a body (20). Said body (20) is fixed to the body of the control valve where the throttling locking valve (10) is used. The body (20) is essentially provided in a cylindrical form. There is a center opening (21) extending along a center axis (a) of the body (20). The center opening (21) comprises a primary part (22) and a secondary part (24). The primary part (22) and the secondary part (24) are separated from each other by means of a step (25). The diameter of the primary part (22) is greater than the diameter of the secondary part (24). In other words, the center opening (21) is provided so as to have a diameter which is greater at the primary part (22) side than at the secondary part (24) side. Thus, the center opening (21) narrows at the step (25) part. There are screw threads (23) extending at least partially along the wall of the primary part (22).

There is at least one locking screw (30) placed at least partially into the body (20). The locking screw (30) has a body part (31), a threaded part (32), a handle part (35) and a pin part (36). When the locking screw (30) is placed into the body (20), while the body part (31) is inside the body (20), the handle part (35) and the pin part (36) extend outwardly from the two sides of the body (20). The body part (31) is provided in a stepped form in a compliant manner to the primary part (22) and the secondary part (24). The region of the body part (31) which remains inside the primary part (22) is provided as a threaded part (32). In other words, inside the primary part (22), there are threads which are compliant to the screw threads (23) on the outer wall of the body part (31).

There is at least one peripheral channel (33) provided in the region which is between the threaded part (32) and the handle part (35). There is at least one sealing element (34) placed into the peripheral channel (33). The sealing element (34) is at least partially rested to the wall of the secondary part (24). Thus, foreign substances like powder are prevented from entering into the body (20) through the handle part (35).

There is at least one valve plug (40) which prevents leakage of the oil, which exists in the control valve provided on the pin part (36) provided on one side of the body part (31) of the locking screw (30), to the outer medium and into the body. The valve plug (40) is essentially provided in a cylindrical form. There is at least one bore (41) provided at the center of the valve plug (40). The pin part (36) is placed into said bore (41). There is at least one inner channel (42) provided at the inner wall of the bore (41). Moreover, there is at least one outer channel (43) provided at the outer wall of the valve plug (40). There is at least one first elastic element (44) provided inside said inner channel (42). Moreover, there is at least one second elastic element (45) provided inside said outer channel (43).

Fluid passage into the body (20) is prevented by means of the elastic elements (44).

In the subject matter throttling locking valve (10), the locking screw (30) is placed to the body (20) such that firstly the handling part (35) enters into the center opening (21). The locking screw (30) is pushed until the threaded part (32) arrives at the screw threads (23). Afterwards, the locking screw (30) is rotated and is fixed into the body (20). In other words, when the handle part (35) in the throttling locking valve (10) is rotated, the locking screw (30) moves forwardly and backwardly in the direction of the center axis (a) according to the rotation direction. When the threaded part (32) is stopped to the end of the screw threads (23) during the movement of the locking screw (30), the locking screw (30) is fixed. Thus, removal of the locking screw (30) from the body (20) is prevented.

The protection scope of the present invention is set forth in the annexed Claims and cannot be restricted to the illustrative disclosures given above, under the detailed description. It is because a person skilled in the relevant art can obviously produce similar embodiments under the light of the foregoing disclosures, without departing from the main principles of the present invention.

### REFERENCE NUMBERS

10 Throttling locking valve
20 Body
21 Center opening
22 Primary part
23 Screw thread
24 Secondary part
25 Step
30 Locking screw
31 Body part
32 Threaded part
33 Peripheral channel
34 Sealing element
35 Handle part
36 Pin part
40 Valve plug
41 Bore
42 Inner channel
43 Outer channel
44 First elastic element
45 Second elastic element
a Center axis

1. A throttling locking valve (10) for a control valve used in tractor hydraulic lifters and having a body (20) and a locking screw (30) provided inside the body (20), characterized by comprising a center opening (21) wherein the locking screw (30) is placed inside the body (20), and a screw thread (23) provided at the wall of the center opening (21) and at least one threaded part (32) provided on the locking screw (30).

2. A throttling locking valve (10) according to claim 1, wherein the locking screw (30) comprises at least one handle part (35) extending outwardly from one side of the body (20).

3. A throttling locking valve (10) according to claim 2, wherein at least one peripheral channel (33) is provided at the outer wall on the side of the handle part (35) of the locking screw (30) and at least one sealing element (34) is provided inside said peripheral channel (33).

4. A throttling locking valve (10) according to claim 1, wherein the locking screw (30) comprises at least one pin part (36) extending outwardly from one side of the body (20).

5. A throttling locking valve (10) according to claim 4, wherein at least one valve plug (40) is provided on the pin part (36).

6. A throttling locking valve (10) according to claim 5, wherein the valve plug (40) comprises at least one inner channel (42) provided at a bore thereof wherein the pin part (36) is placed and at least one first elastic element (44) is provided inside said inner channel (42).

7. A throttling locking valve (10) according to claim 5, wherein at least one outer channel (43) is provided on the outer wall of the valve plug (40) and at least one second elastic element (45) is provided inside said outer channel (43).

8. A throttling locking valve (10) according to claim 1, wherein a first part (22) and a second part (24), which form the center opening (21), is provided.

9. A throttling locking valve (10) according to claim 1, wherein at least one step (25) is provided between the second part (24) and the first part (22) having a greater diameter than the second part (24).
